(19) United States
(12) Patent Application Publication
(10) Pub. No.: US 2006/0104201 A1
(43) Pub. Date: May 18, 2006

(54) Unit and a method for handling a data object

(76) Inventors: Krister Sundberg, Sollentuna (SE); Ann-Christine Eriksson, Vallentuna (SE)

Correspondence Address: ERICSSON INC., 6300 LEGACY DRIVE, M/S EVR C11, PLANO, TX, 75024, US

(21) Appl. No.: 10/527,515

(22) PCT Filed: Oct. 1, 2002
(86) PCT No.: PCT/SE02/01786

§ 371 Date: Mar. 10, 2005

(51) Int. Cl. H04L 12/26; H04J 1/16; H04L 12/56; H04L 12/54

(52) U.S. Cl. 370/230; 370/412; 370/428; 370/235

(57) ABSTRACT

The present invention relates to a unit and a method for handling a data object that is to be transmitted over a link (39, 40, 41, 42), said data object being divided into at one least data unit. According to the invention the data unit that is in turn to be transmitted over the link (39, 40, 41, 42) should be handled differently depending on where a buffer fill level in a buffer (33, 34, 35, 36, 37, 38) preceding the link (39, 40, 41, 42) is in relation to at least one buffer threshold (51, 52, 53, 54, 55, 56, 57, 58, 59) in order to minimise end-to-end delay.

### TECHNICAL FIELD OF THE INVENTION

The invention relates in general to a unit and a method for handling a data object that is to be transmitted over a link, said data object being divided into at least one data unit.

### DESCRIPTION OF RELATED ART

Traditionally cellular systems, for example the Global System for Mobile telecommunications (GSM), have been used to transmit speech and they have implemented circuit switching. In circuit switching a certain amount of transmission resources is reserved in all the networks through which the connection goes. For data applications there is usually need to transmit bursts of data every now and then. For this kind of data transmission circuit switching is not an efficient way to transmit data.

General Packet Radio Service (GPRS) is an example of a wireless packet switched network. It is an addition to the GSM system. Using GPRS it is possible to provide a certain portion of the radio resources of the GSM radio access network for users who wish to transmit packet data. The statistical multiplexing, i.e. the fact that every user is not transmitting packets at the same time, allows a certain radio channel to be used efficiently by many users.

Enhanced Data Rate for GSM Evolution (EDGE) is an enhanced version of GSM that provides circuit switched and packet switched data transmission at a higher rate than current GSM or GPRS. Different versions are EDGE-based GPRS (EGPRS) and EDGE-based Circuit Switched Data (ECSD).

Protocols are sets of rules with which two points can exchange data in a defined way. Different protocols may be layered, e.g. according to a version of the general OSI-model.

When sending a data object packet switched, the data object is divided into packets. For each layer the packets are embedded into data units of another protocol. “Embedding” refers both to the possibility of encapsulation as well as segmentation. “Data unit” is here used as a general name for packets, packet data units, frames, radio blocks or any other name it may be called in the different protocols.

A problem, especially in radio based systems, is that whole or part of data units may be made unrecoverable on the way due to e.g. interference or attenuation. This can be solved with retransmission of lost data units. Another solution is to add parity bits to the data units. If part of the data unit is unrecoverable it may then be possible to recreate it using the parity bits. There are more and less complicated ways of coding in this way. The more parity bits that are used, the larger part of the data unit may be reconstructed. On the other hand if many parity bits are used, the useful part of the data unit will decrease, thus also making the total transmittal time of an object longer.

In WO 00/24152 there is an invention trying to optimise the coding. First type data units belonging to one and the same higher layer second type data unit or a specified send window, are given different reliability levels depending on if the first type data units are sent first or last of the first type data units within said second type data unit or send window. In the given example this is done on RLC (radio link control) blocks within the same LLC PDU (logical link control packet data unit)). A disadvantage with this is that it is a complicated solution, which requires analysis or knowledge of each first type data unit. This also consumes processor capacity.

### SUMMARY OF THE INVENTION

An object with the invention is to shorten end-to-end transmission delays in packet transmission networks.

Problems with the solution in WO 00/24152 is that it is complicated and consuming processor capacity. In the present invention it is realised that WO 00/24152 actually is suboptimising the problem and that the problem can be solved in a simpler and more efficient way.

According to the invention the delay time can be optimised by investigating the size of the object to be sent and/or keep track of how much data that is remaining to be sent. This is in contrast with WO 00/24152, where each and every data unit is analysed.

According to the invention, for small objects the transmission should preferably be made more secure, i.e. more parity bits should be used. This will decrease the risk of retransmission and the total delay will thus be less. The extra bits will of course also cause a delay, but this delay will be smaller than a retransmission delay would have been. For larger objects, retransmissions will cause less delay, since other data units can be sent in the waiting time. Thus, larger objects should preferably be sent with less or no security, to avoid the delay from the extra bits. This is with the possible exception of the end of the object, which preferably should be sent in a more secure mode following the reasoning above.

This is easiest done by using a buffer preceding a link over which data units are to be transmitted and setting at least one buffer threshold on the buffer fill level in said buffer. A data unit that is in turn to be transmitted over the link should then be handled differently depending on where the buffer fill level is in relation to the at least one buffer threshold.

Preferably, the link should be made more secure, e.g. by using a coding scheme giving a higher security, if the buffer fill level is below the at least one buffer threshold, than if the buffer fill level is above said at least one buffer threshold. This will enable both that smaller objects are sent with higher security and that the ends of larger objects are sent with higher security. There are also other embodiments.

The advantages are that end-to-end transmission delays are shortened in a simple and cheap way.

The invention will now be described in more detail with reference to enclosed drawings.

### DESCRIPTION OF THE DRAWINGS

FIGS. 1a and b shows schematically a problem underlying the invention

FIG. 2 shows parts of a GPRS or EGPRS system

FIG. 3 shows a simplified view of a protocol stack for the system in FIG. 2

FIG. 4 shows an embodiment of the invention

FIG. 5 shows polling for acknowledgement

### DESCRIPTION OF PREFERRED EMBODIMENTS

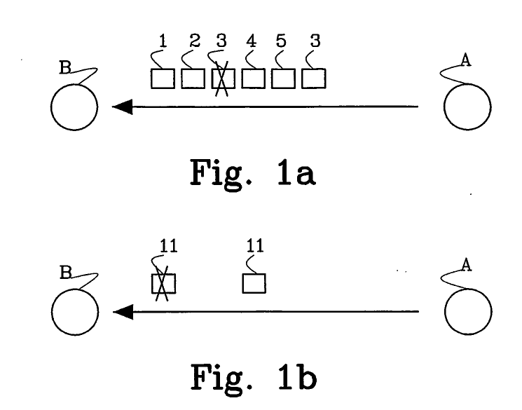

In FIG. 1a is shown a problem realised for the invention. In a system including a first node A and a second node B, the first node A is transmitting a data object divided into five data units 1, 2, 3, 4, 5 to the second node B. Let us say that the third data unit 3 never reaches the second node B. If there is some type of transmission control in the system, then the second node B will signal to the first node A that it has not received the third data unit 3 (negative acknowledgement). Alternatively, the second node B will signal to the first node A that the second node B did receive the first, second, fourth and fifth data unit 1, 2, 4, 5, whereupon the first node A will draw the conclusion that the second node A did not receive the third data unit 3 (positive acknowledgement).

This leads to that the first node A will retransmit the third data unit 3. Considering that it will take some time before the first node is informed about the missing data unit, the third data unit 3 will perhaps be retransmitted after the fifth data unit 5. The second node B can then reassemble the data units in the right order and have received the complete data object with only one cycle delay.

Compare now FIG. 1b where the data object includes only one data unit 11. If that data unit 11 is lost and consequently retransmitted two cycles later, just as in FIG. 1a, the delay calculated as a percentage of the transmittal time will be much larger than in FIG. 1a. In FIG. 1a two other data units could be sent while waiting for retransmission of the third data unit 3, but in FIG. 1b there is just useless waiting time. Note also that if in FIG. 1a, the fifth and last data unit 5 would be lost there will also be useless waiting time, since there are no more data units to send, even though the delay calculated as a percentage of the transmittal time of course still would be less than in FIG. 1b, since the total object transmitted in FIG. 1a is much larger than in FIG. 1b.

According to the invention the delay time can be optimised by investigating the size of the object to be sent and/or keep track of how much data that is remaining to be sent. For small objects the transmission should preferably be made more secure, i.e. more parity bits should be used. This will decrease the risk of retransmission and the total delay will thus be less. The extra bits will of course also cause a delay, but this delay will be smaller than a retransmission delay would have been, compare FIG. 1b.

For larger objects, retransmissions will cause less delay, since other data units can be sent in the waiting time. Thus, larger objects should preferably be sent with less or no security, to avoid the delay from the extra bits. This is with the possible exception of the end of the object, which preferably should be sent in a more secure mode following the reasoning above.

This is easiest done by using a buffer preceding a link over which data units are to be transmitted and setting at least one buffer threshold on the buffer fill level in said buffer. A data unit that is in turn to be transmitted over the link should then be handled differently depending on where the buffer fill level is in relation to the at least one buffer threshold.

Preferably, the link should be made more secure, e.g. by using a coding scheme giving a higher security, if the buffer fill level is below the at least one buffer threshold, than if the buffer fill level is above said at least one buffer threshold. This will enable both that smaller objects are sent with higher security and that the ends of larger objects are sent with higher security. There are also other embodiments, which will be described in the detailed example below.

This can be useful in any system. However, the greatest advantages will be found in radio systems where the radio interface may cause a lot of delay. An exemplary implementation in GPRS or EGPRS will be disclosed. It is however to be noted that the invention can be implemented in a similar way also in other systems, such as UMTS (Universal Mobile Telecommunications System) and W-LAN (Wireless Local Area Network).

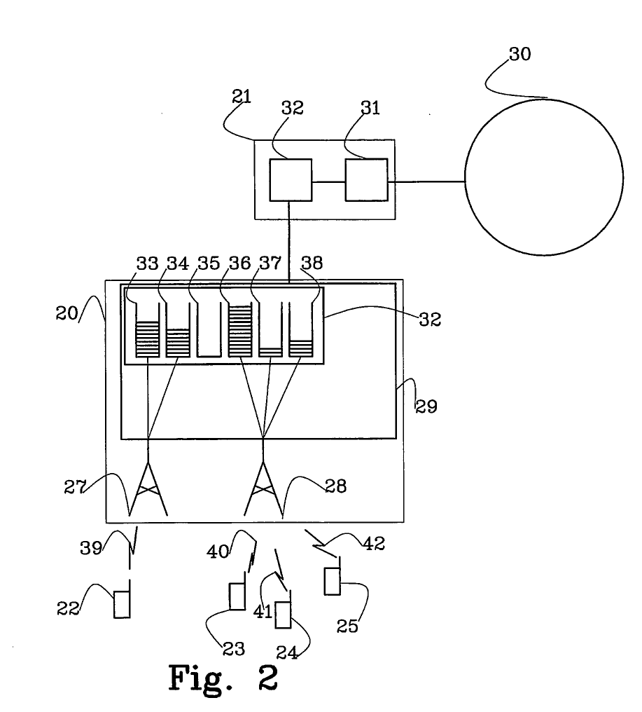

FIG. 2 presents a schematic diagram of a radio access network 20, which can transmit data, and a core network 21. A mobile station (MS) 22, 23, 24, 25 communicates with a base transceiver station (BTS) 27, 28—or base station, for short—over links 39, 40, 41, 42. One or more base stations 27, 28 are connected to a base station controller (BSC) 29. The base station controller is responsible, for example, for allocation of radio resources and for handling handovers, where a mobile station changes the base station it communicates with. The base stations 27, 28 and base station controllers 29 are included in a base station system (BSS) 20.

The core network 21 comprises GPRS supporting nodes (GSN) 31, 32. Of these nodes, the one which is on the edge towards a data network 30, for example the Internet, is called a Gateway GPRS supporting node (GGSN) 31. Data units may run through many GSNs, which act as routers. A mobile station, which is the endpoint of the data connection, is reachable through one base station controller and the GSN connected to this base station controller is called Serving GPRS support node (SGSN) 32.

User data is transferred transparently between the mobile station and the external data networks with a method known as encapsulation and tunnelling: data units are equipped with GPRS-specific protocol information and transferred between the mobile station and the GGSN. In order to access the GPRS services, a mobile station first makes its presence known to the network by performing a GPRS attach. This operation establishes a logical link between the mobile station and the SGSN, and makes the mobile station available for, for example, paging via SGSN and notification of incoming GPRS data.

The SGSN keeps track of the individual mobile station's location and performs security functions and access control. The GGSN provides interworking with external packet-switched networks, and is connected with SGSNs via an IP-based GPRS backbone network.

The BSC 29 includes among other things a packet control unit (PCU) 32, which among other things include a number of PCU buffers 33, 34, 35, 36, 37, 38. A mobile station communicating with the BSC is assigned one or more IP addresses e.g. for communication with the Internet. Each IP address is associated with an individual PDP (Packet Data Protocol) context in the mobile station, the SGSN and the GGSN. The PDP context contains e.g. routing information and Quality of Service parameters. After a PDP context has been set up, a packet flow context (PFC) will be set up between the BSS and the SGSN. Said PFC may work for one or more PDP contexts.

The PCU buffers in a PCU include a cell buffer, which in its turn includes a number of MS buffers. Each MS buffer may then be divided into a number of PFC buffers. Each PFC is associated with one PFC buffer each. In the example in FIG. 2 the first mobile station 22 uses two PFCs and thus two PFC buffers 33, 34, while the other mobile stations 23, 24, 25 uses one PFC each and thus one PFC buffer 36, 37, 38 each. The PCU buffers that are of main interest for the present invention are the PFC buffers, but the MS buffers may also be used.

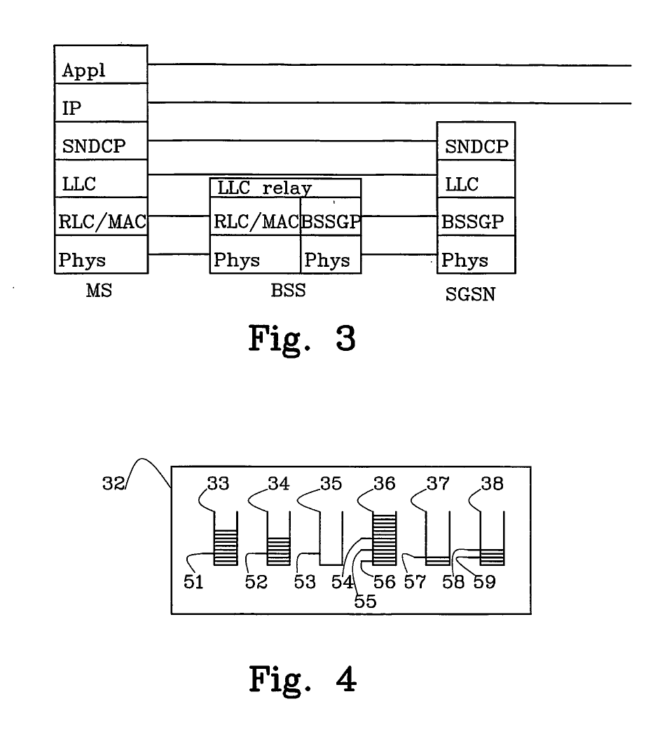

Functions applying digital data transmission protocols are usually described as a stack according to the OSI (Open Systems Interface) model, where the tasks of the various layers of the stack, as well as data transmission between the layers, are exactly defined. FIG. 3 presents a simplified view of the protocol layers in GPRS and EGPRS.

The lowest protocol layer between the mobile station and the base station subsystem is the physical layer (PHYS). Above it, there is a radio link control/media access control (RLC/MAC) layer. On top of it there is a logical link control (LLC) layer and a Subnetwork Dependent Convergence Protocol (SNDCP) layer.

The mobile station includes also higher layers, simplified shown as IP layer and application layer for communication e.g. with an Internet server.

Large information blocks from the SNDCP layer are segmented and placed in LLC PDU:s (Packet Data Units). Different frame lengths are possible, but normally the maximum permitted length is 1600 octets. Each LLC PDU includes parity bits for Automatic Repeat ReQuest (ARQ) on the LLC level and a frame header (FH) with routing information.

In the LLC layer the LLC PDU is broken up in a number of radio blocks, which also each includes a block header (BH) and parity bits for selective ARQ. Two types of radio blocks are used: data blocks and signalling blocks.

When the radio blocks are transmitted over the radio interface, a MAC header is attached to the radio block. The transmitted radio blocks are called RLC/MAC blocks and are coded. The coding adds redundancy to the data, and the aim of the coding is to recover the data even if some occasional transmission errors occurs. In addition to coding, the data is usually also interleaved. This means, for example, that sequential data chunks are not sent one after other, but in some other order. In this way more bursty transmission errors can be tolerated.

Coding may be made in different ways. For GPRS are defined coding schemes CS-1, CS-2, CS-3 and CS-4 and for EGPRS are defined modulation and coding schemes MCS-1, MCS-2, MCS-3, MCS-4, MCS-5, MCS-6, MCS-7, MCS-8 and MCS-9. The lower the coding scheme number is, the more bits are used and consequently the more secure and the slower the transmission becomes. On the other hand, the higher the coding scheme number is, the less bits are used and consequently the less secure and the faster the transmission becomes. MCS-9 uses no coding at all.

There exist different modes of Link Quality Control (LQC) to improve the use of the coding. In GPRS, Link Adaptation (LA) is used. Simplified it works like this: Let us say that the BSS is sending radio blocks with CS-4. The mobile station measures channel quality and reports with “acknowledge” or “not acknowledge”. If the quality is bad the BSS changes the coding and starts sending radio blocks with CS-3 instead. If the mobile station then still reports that the quality is bad the BSS changes the coding and starts sending radio blocks with CS-2 instead etc.

In EGPRS, Link Adaptation is used combined with Incremental Redundancy (IR). Simplified, IR works like this: The BSS sends data. The mobile station reports faulty radio blocks, if any, with “not acknowledge”. The BSS then sends coding bits for the faulty radio blocks. The mobile station can then combine the coding bits with the original radio blocks. The mobile station reports if faulty radio blocks still exist. If faulty blocks still exist, then the BSS sends more coding bits for the faulty radio blocks. The mobile station can then combine the new coding bits with the radio blocks etc until the mobile station reports “no faulty radio blocks” or until there are no more coding bits to send. In the latter case the a retransmission is made and the process starts all over again.

The disadvantage with these LQC techniques are that there are very much delay in the case where a retransmission has to be made.

As described above, the present invention handles the data units in a more flexible way depending on the length of the transmission and if it is the end of the transmission. This is easiest done by checking the fill level of the PCU buffer in the BSC, see FIG. 4. There exist also buffers in other units of the system which may be used, in particular there is a corresponding buffer in the SGSN. It is however considered most advantageous to use the PCU buffer in the BSC, considering that it is closest to the radio interface where most of the data loss will occur. In other systems any suitable buffer in any unit preceding the link on which the data units are to be transmitted, may be used.

If the PCU buffer fill level is high then it is probably somewhere in the beginning or middle of a long transmission of a large object and thus the coding can be less secure, according to the reasoning above. Thus, a coding scheme with a higher number should be used.

If on the other hand the PCU buffer fill level is low then it is probably either a short transmission of a small object or somewhere in the end of a long transmission of a large object and thus the coding can be more secure, according to the reasoning above. Thus, a coding scheme with a lower number should be used. To trigger the change of coding scheme, one or more buffer thresholds 51, 52, 53, 54, 55, 56, 57, 58, 59 are used in the PCU buffer. The buffer threshold or thresholds may be defined in e.g. kbytes or data units in the buffer. It is probably enough to use just one buffer threshold.

Naturally, the invention would work irrespective on what level the buffer threshold or thresholds are put. To find the best level for the buffer threshold or thresholds requires some experimentation to achieve optimal performance. A qualified guess when one buffer threshold is used, could be that the best level might be on a level somewhere corresponding to e.g. 1-3 IP packets, which would roughly be 1-3 LLC PDU's or about 0.5-4.5 kbytes. The buffer threshold needs not be set on whole LLC PDU's, but might be e.g. 1.5 LLC PDU's.

According to a further embodiment, the coding schemes—or any other equivalent ways of making a link secure—may also be changed depending on the radio quality. As an example, let us say that there is one buffer threshold. When the radio quality is good, then e.g. the coding scheme MCS-5 may be used when the buffer fill level is below the buffer threshold and the less secure coding scheme MCS-8 may be used when the buffer fill level is above the buffer threshold. Let us now say that the radio quality becomes much worse. Then the coding schemes both above and below the buffer threshold are chosen more secure than before, but still having a coding scheme more secure below the buffer threshold—such as MCS-3, than above the buffer threshold—such as MCS-6. In this embodiment there is thus also at least one threshold on the radio quality. With more than one radio quality threshold, there will be a corresponding number of different sets of pairs of coding schemes. Naturally, sets of triplets, quadruplets etc may be defined in the same way, if there is more than one buffer threshold, but there is no need to complicate matters unnecessarily.

According to a further embodiment, said buffer threshold or thresholds may also be used to select LQC mode, if that is used in the system. Since IR may give very long delays in case of retransmissions, it should preferably not be used when the buffer fill level is low. LA on the other hand may be used irrespective of if the buffer fill level is high or low. When IR is used, a coding scheme with higher number may be used than without IR. This is because, when IR is used, the mobile station saves earlier sent radio blocks and adds them with retransmitted radio blocks. Thus, fewer coding bits are needed per radio block.

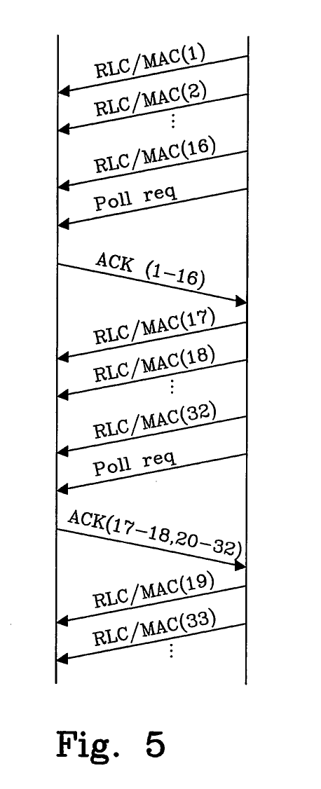

In FIG. 5 is shown schematically the sending of acknowledgements on the RLC/MAC layer. In protocols such as TCP (transmission control protocol) acknowledgements on received packets are sent automatically under certain rules. However, the RLC/MAC protocol uses polling to fetch acknowledgements, which is seen in FIG. 5: A BSS transmits an object to a mobile station divided into several data blocks RLC/MAC (1)-(16). After e.g. sixteen data blocks the BSS also transmits a polling request Poll Req. The Mobile station then transmits an acknowledgement on the received data blocks, whereupon the BSS retransmits the not acknowledged data blocks and it also transmits sixteen new data blocks etc.

According to a further embodiment of the invention this polling should be made more often when the buffer fill level is below the buffer threshold or threshold. E.g. with one buffer threshold, polling could performed every 16^{th} data block when the buffer fill level is above the buffer threshold, and every 4^{th} data block when the buffer fill level is below the buffer threshold. There may also be other equivalent ways of making the acknowledgements appear more often than using the polling.

It is possible for a user of a mobile station to have different types of subscriptions with different types of priority. This means that in the radio interface data units for a mobile station with a high priority is sent more often than for a mobile station with a lower priority. The subscriptions may e.g. be called gold, silver and bronze, where gold gives the highest priority and bronze gives the lowest priority. According to a further embodiment of the present invention, if a first mobile station with a low priority is involved in a transmission with said low priority, then the end of the transmission should be sent with higher priority. Thus, if the buffer fill level goes below the buffer threshold, then the remaining data units are sent with higher priority. This will of course cause dips in the transmission performances for the other mobile stations. On the other hand, when the transmission of the first mobile station ends, the other mobile station will have more bandwidth to share. Thus, it can be an advantage to sort of “get rid of” the transmission of the first mobile station faster.

According to a further embodiment, in the case when the mobile station is going to do a handover to another cell, the upper part of the buffer above at least one buffer threshold should be moved to another corresponding buffer in the other cell. To speed up matters said upper part of the buffer may be considered as not being there already before the actual move has taken place. Thus, the remaining part below the at least one buffer threshold may be treated as the end of a transmission with higher security etc.

All these embodiments may of course be combined with each other. They may also be combined with the solution in WO 00/24152. The latter combination may be beneficent especially in GPRS where the sending window is small, but is perhaps of less use in EGPRS, where the sending window is much larger.

The possibility to use links with different security is not unique to GPRS and EGPRS. It is also possible in e.g. UMTS and W-LAN, even if perhaps not always solved by using different coding schemes. In UMTS, preferably buffers in the radio network controller may be used. The invention may of course also be used in systems that today does not have the possibility to control the security of links, but that would gain advantages by introducing it.

Further, it is not necessary to only employ the invention on the low OSI layer exemplified in this description, but it is of course possible to implement also on other layers.

1. Method for handling a data object that is to be transmitted over a link within a packet communication network, said data object being divided into at one least data unit, comprising the steps of:
assigning a buffer for storing said data unit to be transmitted over said link;
assigning at least one buffer threshold level for said assigned buffer;
determining a current buffer fill level for said buffer; and
handling the data unit that is in turn to be transmitted over the link, differently depending on where said buffer fill level for said buffer is in relation to said at least one buffer threshold level in order to minimise end-to-end delay.

2. Method according to claim 1, wherein said step of handling the data unit further comprises the step of using a coding scheme for security coding of the data unit giving higher security for the link, if the buffer fill level is below the at least one buffer threshold level, than if the buffer fill level is above said at least one buffer threshold level.

3. Method according to claim 1, further comprising the step of using coding schemes for security coding of the data unit giving higher security when the radio quality is worse than at least one radio quality threshold, than when the radio quality is better than said at least one radio quality threshold.

4. Method according to claim 1, further comprising the step of polling more often for acknowledgement, when the buffer fill level is below the at least one buffer threshold level than when the buffer fill level is above the at least one buffer threshold level.

5. Method according to claim 1, further comprising the step of giving a higher priority for the data units using said buffer compared to other data units sharing the same link, when the buffer fill level is below the at least one buffer threshold level than when the buffer fill level is above the at least one buffer threshold level.

6. Method according to claim 1, further comprising the step of using incremental redundancy for the transmission only when the buffer fill level is above the at least one buffer threshold level, when the method is used in an EDGE Based GPRS (EGPRS) system.

7. Method according to claim 1, further comprising the steps of:
moving the upper part of the buffer above at least one threshold to another buffer; and
by treating the lower remaining part of the buffer below the at least one threshold as if the upper part had moved, already before the actual moving has taken place.

8. A packet communication system arranged to handle a data object that is to be transmitted over a link, said data object being divided into at one least data unit, comprising:
a buffer for storing said at least data unit to be transmitted over said link wherein said buffer is assigned with at least one buffer threshold level;
a processor unit for handling the data unit that is in turn to be transmitted over the link wherein said processor unit further determines a buffer fill level associated with said buffer and handles said data unit differently depending on where said buffer fill level in said buffer is in relation to said at least one buffer threshold level in order to minimise end-to-end delay.

9. Unit according to claim 8, wherein the unit is arranged to using a more secure link by using a coding scheme for security coding of the data unit giving higher security, if the buffer fill level is below the at least one buffer threshold level, then if the buffer fill level is above said at least one buffer threshold level.

10. Unit according to claim 8, wherein the unit is arranged to use coding schemes for security coding of the data unit giving higher security when the radio quality is worse than at least one radio quality threshold, than when the radio quality is better than said at least one radio quality threshold.

11. Unit according to claim 8, in that the unit is arranged to poll for acknowledgement more often, when the buffer fill level is below the at least one buffer threshold level than when the buffer fill level is above the at least one buffer threshold level.

12. Unit according to claim 8, wherein the unit is arranged to give a higher priority for the data units using said buffer compared to other data units sharing the same link, when the buffer fill level is below the at least one buffer threshold level than when the buffer fill level is above the at least one buffer threshold level.

13. Unit according to claim 8, wherein the unit is arranged to move the upper part of the buffer above at least one threshold to another buffer; and arranged to treat the lower remaining part of the buffer below the at least one threshold as if the upper part had moved, already before the actual moving has taken place.

14. Unit in an EDGE Based GPRS (EGRPS) system according to claim 8, wherein the unit is arranged to use incremental redundancy for the transmission only when the buffer fill level is above the at least one buffer threshold level.

15. Unit in a GPRS or an EGPRS system according to claim 8, wherein the buffer is a mobile station (MS) or packet control unit (PCU) buffer.

16. Unit in a GPRS or an EGPRS system according to claim 8, wherein the unit is a base station, a base station controller, or a serving GPRS support node.

17. Unit in a UMTS system according to claim 8, wherein the unit is a radio network controller.
